(19) United States
(12) Patent Application Publication
(10) Pub. No.: US 2026/0009185 A1
(43) Pub. Date: Jan. 8, 2026

(54) MICROPLASTIC-FREE COATED PAPER

(71) Applicant: SAPPI NETHERLANDS SERVICES B.V., Maastricht (NL)

(72) Inventor: Sandra HENDRIX, Maastricht (NL)

(21) Appl. No.: 18/992,040

(22) PCT Filed: Jul. 13, 2023
(86) PCT No.: PCT/EP2023/069433

§ 371 Date: Jan. 7, 2025

(30) Foreign Application Priority Data
Jul. 26, 2022 (EP) 22187041.3

(51) Int. Cl. D21H 19/54; C09D 11/14; D21H 19/50; D21H 19/56; D21H 27/00

(52) U.S. Cl. CPC D21H 19/54; C09D 11/14; D21H 19/50; D21H 19/56; D21H 27/00

(57) ABSTRACT

A printing paper comprising at least one ink receiving topcoat, wherein the ink receiving topcoat comprises a pigment composition and a binder composition, the binder composition comprising a mixture of at least one starch, and one or both of at least one protein and at least one water-soluble polymer, characterized in that the binder composition comprises the at least one protein in an amount of at least 5 weight percent, when present, and comprises the at least one water-soluble polymer in an amount of at least 2.5 weight percent, when present, based on the weight of the binder composition.

### TECHNICAL FIELD

The present invention relates to printing paper coated with an ink receiving topcoat, as well as a method of manufacturing the printing paper coated with an ink receiving topcoat and a method of manufacturing an aqueous ink receiving topcoat composition.

### PRIOR ART

In recent years, voluntary efforts have been made to reduce or eliminate the use of microplastics in a variety of products. In view of the now generally accepted need to reduce microplastics, lawmakers are considering introducing or amending regulation that prohibits or limits the use of microplastics.

In paper coatings, it is well-known to use latexes of synthetic polymers such as styrene-butadiene latexes, as binders for pigment particles in graphical paper topcoats. Such latexes are stable dispersion of polymer microparticles in an aqueous liquid.

Therefore, it is desirable to reduce the use of such latexes in paper products to make them more environmentally friendly. One solution is to provide a coating in which the latex is replaced by aqueous starch dispersions or solutions, or cold-water soluble starch (dry addition directly into the coating). However, the use of starch is not without its own problems.

While digital printing is expanding its market share, the well-established method of offset printing still dominates the print market, and most papers used in offset and digital printing incorporate topcoats that comprise a latex.

In offset printing, a mixture of water and other chemicals is distributed by the dampening system on the printing press used in offset lithography. This mixture is known as “fountain solution” (http://printwiki.org/Fountain_Solution).

Offset printing operates on the principle that oil and water do not mix to any great extent; offset presses first treat metal printing plates with a fountain solution, which works to desensitize the non-image areas, rendering them ink-repellent, while leaving the image areas free to receive the oil-based ink. The fountain solution is applied to the plate through a series of rollers in a variety of configurations and is mostly constituted of water and isopropyl alcohol or in some cases, of water and a non-alcoholic alternative to isopropyl alcohol.

The problem with topcoats that incorporate starch dispersions instead of latexes is that they are very sensitive to the fountain solution, which significantly increases picking, splitting, and tearing of the paper during offset printing. Additionally, the sensitivity to fountain solution influences the quality of the printability of the paper due to wet repellence of the ink and/or surface roughing of the paper surface. It is therefore desirable to provide a topcoat that, when applied to a base paper (or a pre-coated paper), avoids the occurrence of such printing defects and results in perfect print quality.

Currently, most printing papers are custom-made to be used in one of the two predominant printing methods, offset and digital, and a paper made for use in one of these methods generally performs poorly when used in the other. This leads to printers having to keep a stock of both types of paper, which is economically disadvantageous. It is therefore desirable to provide a printing paper that can be used in both printing methods.

There exists therefore a need to reduce the use of latexes in paper products while at the same time providing an alternative paper product that can be used in an offset printing method, in particular in a wet offset printing method, without the occurrence of printing defects such as picking, splitting, and tearing of the paper while keeping the high print quality that can be achieved by use of latexes. Ideally, such a paper should be versatile and be usable both in digital and offset printing.

### SUMMARY OF THE INVENTION

The present invention provides a printing paper coated with an ink receiving topcoat, as well as a method of manufacturing the printing paper coated with an ink receiving topcoat and a method of manufacturing an aqueous ink receiving topcoat composition that resolve the above problems. In particular, the ink receiving coatings that find use in the various embodiments of the present inventions are free, i.e. essentially free of microplastic because the latex binders in the binder composition of the ink receiving topcoat have been replaced with alternative binders that nonetheless afford excellent printing quality when used in printing process that employ so-called fountain solutions as well as in digital printing processes.

It is therefore a first object of the present invention to provide a printing paper comprising at least one ink receiving topcoat, wherein the ink receiving topcoat comprises a pigment composition and a binder composition, the binder composition comprising a mixture of at least one starch, and one or both of at least one protein and at least one water-soluble polymer, characterized in that the binder composition comprises the at least one protein in an amount of at least 5 weight percent, when present, and comprises the at least one water-soluble polymer in an amount of at least 2.5 weight percent, if present, based on the weight of the binder composition.

Thus, in one embodiment, in the ink receiving topcoat, the binder composition may comprise a mixture of at least one starch, at least one protein and at least one water-soluble polymer, while in another embodiment the binder composition may comprise a mixture of at least one starch and at least one water-soluble polymer, without the at least one protein, or a mixture of at least one starch and at least one protein, without the at least one water-soluble polymer.

It is further a second object of the present invention to provide a use of a printing paper according to the first object in an offset printing process, flexo printing process, gravure printing process or a digital printing process.

It is yet further a third object of the present invention to provide an aqueous ink receiving topcoat composition comprising a pigment composition and a binder composition, wherein the binder composition comprises a mixture of at least one starch, and one or both of at least one protein and at least one water-soluble polymer, and optionally a plasticizer such as glycerol or sorbitol, characterized in that the binder composition comprises the at least one protein in an amount of at least 5 weight percent, when present, and comprises the at least one water-soluble polymer in an amount of at least 2.5 weight percent, when present, based on the dry weight of the binder composition.

It is furthermore a fourth object of the present invention to provide a process for the manufacture of a printing paper having an ink receiving topcoat, preferably a printing paper according to the first object.

It is a last and fifth object of the present invention to provide a process of manufacturing a printing paper having an ink receiving topcoat, preferably a printing paper according to the first object, wherein the process includes the steps of:
a. forming an aqueous ink receiving topcoat composition from a binder composition and a pigment composition, the binder composition comprising a mixture of at least one starch, and one or both of at least one protein and at least one water-soluble polymer, characterized in that the binder composition comprises the at least one protein in an amount of at least 5 weight percent, when present, and comprises the at least one water-soluble polymer in an amount of at least 2.5 weight percent, when present, based on the dry weight of the binder composition, preferably an aqueous ink receiving topcoat composition according to the third object, or providing an aqueous ink receiving topcoat composition according to the third object of the present invention,
b. applying the aqueous ink receiving topcoat composition, preferably in an amount of about 5 to 25 gsm, more preferably in an amount of 8 to 15 gsm, most preferably in an amount of 10 to 12 gsm, on a base paper or a pre-coated paper, in particular via a blade coater,
c. drying at least the aqueous ink receiving topcoat composition such as to form a printing paper having an ink receiving topcoat, preferably a printing paper according to the first object.

Further embodiments of the invention are laid down in the dependent claims.

### DESCRIPTION OF PREFERRED EMBODIMENTS

In the context of the present invention, the term “water-insoluble polymer” means that the polymer is not soluble in water at 20° C., and in particular has a solubility in water at 20° C. of less than 1 mg/l (10⁻⁶ w/v %), and preferably in particular of less than 10 mg/l (10⁻⁵ w/v %).

In the context of the present invention, the term “water-soluble polymer” means that the polymer is soluble in water at 20° C. in an amount of more than 10 mg/l, and in particular has a solubility in water at 20° C. of at least 40 g/l (4 w/v %).

In the context of the present invention, the term “essentially free of a material” means that the material is present in less than 0.1% w/w %, preferably less than 0.01 w/w %.

It is a first object of the present invention to provide a printing paper comprising at least one ink receiving topcoat, wherein the ink receiving topcoat comprises a pigment composition and a binder composition, the binder composition comprising a mixture of at least one starch, and one or both of at least one protein and at least one water-soluble polymer, characterized in that the binder composition comprises the at least one protein in an amount of at least 5 weight percent, when present, and comprises the at least one water-soluble polymer in an amount of at least 2.5 weight percent, when present, based on the weight of the binder composition.

In one embodiment of the printing paper according to the present invention, one side of the printing paper, or both sides of the printing paper, are coated with the ink receiving topcoat.

In one embodiment of the printing paper according to the present invention, in the ink receiving topcoat, the binder composition may comprise a mixture of at least one starch, at least one protein and at least one water-soluble polymer, while in another embodiment the binder composition may comprise a mixture of at least one starch and at least one water-soluble polymer, without the at least one protein, or a mixture of at least one starch and at least one protein, without the at least one water-soluble polymer.

When the binder composition comprises a mixture of at least one starch, at least one protein and at least one water-soluble polymer, the binder composition comprises the at least one protein in an amount of at least 5 weight percent, preferably at least 10 weight percent, based on the weight of the binder composition.

When the binder composition comprises a mixture of at least one starch and at least one protein, without the at least one water-soluble polymer, the binder composition comprises the at least one protein in an amount of at least 5 weight percent, preferably at least 10 weight percent, more preferably at least 25 weight percent, or 25 weight percent to 35 weight percent, based on the weight of the binder composition.

When the binder composition comprises a mixture of at least one starch and at least one water-soluble polymer, without the at least one protein, the binder composition comprises the at least one water-soluble polymer in an amount of at least 2.5 weight percent, preferably in an amount of at least 15 weight percent, based on the weight of the binder composition. Thus, the binder composition can comprise the at least one water-soluble polymer in an amount of from about 2.5 weight percent, or 15 weight percent, to about 20 weight percent, based on the weight of the binder composition.

In one embodiment of the printing paper according to the present invention, the binder composition, or both binder composition and pigment composition, and preferably the ink receiving topcoat, as a whole, comprises essentially no water-insoluble synthetic polymer and/or microplastics, or is free of water-insoluble synthetic polymer and/or microplastics. Water-insoluble polymer and/or microplastics may be, for example, particles of styrene-butadiene copolymer, (meth)acrylic acid copolymers polyethylene, polycarbonate, polypropylene or polystyrene.

In one embodiment of the printing paper according to the present invention, the at least one protein is whey protein, casein, soy protein, wheat protein such as gluten and preferably is whey protein. Whey protein may be sourced from products such as whey protein isolate or whey protein concentrate. It was found that whey protein has no influence on viscosity of the coating, so the target of high solids content can be met. Further the end paper will have a hydrophobic surface which “protects” the starch in the ink receiving layer from deleterious effects that the fountain solution would otherwise have on the starch during printing.

In one embodiment of the printing paper according to the present invention, the binder composition further comprises a plasticizer such as glycerol or sorbitol. The plasticizer has the purpose of plasticizing the starch within the binder composition.

In one embodiment of the printing paper according to the present invention, the binder composition comprises the at least one protein in an amount of at least 10 weight percent, and preferably in an amount of from 10 to 40 weight percent, more preferably in an amount of from 15 to 25, weight percent, based on the weight of the binder composition.

In one embodiment of the printing paper according to the present invention, the binder composition comprises the at least one starch in an amount of at least 50 weight percent, preferably in an amount of at least 60 weight percent, more preferably in an amount of from 60 to 90 weight percent, based on the weight of the binder composition.

In one embodiment of the printing paper according to the present invention, the binder composition comprises the at least one water-soluble polymer in an amount of at least 2.5 weight percent, preferably in an amount of at least 10 weight percent, more preferably in an amount of from 15 to 25 weight percent, based on the weight of the binder composition. In particular, in the case where the binder composition comprises only the at least one water-soluble polymer in combination with the at least one starch, without the at least one protein, the binder composition comprises the at least one water-soluble polymer in an amount of at least 10 weight percent, preferably in an amount of from 15 to 25, based on the weight of the binder composition.

In one embodiment of the printing paper according to the present invention, when the binder composition comprises a mixture of the at least one protein and the at least one starch, without comprising the at least one water-soluble polymer, it comprises the at least one protein and the at least one starch in a total amount of at least 75 weight percent, or of from 75 to 97.5 weight percent, preferably in an amount of at least 85 weight percent, or of from 85 to 97.5 weight percent, based on the weight of the binder composition. In one embodiment, the binder composition may comprise the at least one protein and the at least one starch in a total amount of at least 97.5 weight percent, more preferably of at least 99 weight percent or 100 weight percent.

In one embodiment of the printing paper according to the present invention, the binder composition and/or pigment composition may further include known additives, such as dispersion agents, foaming agents, optical brighteners, colorants, rheology agents and mixtures thereof. The amount of such additives may, in general, vary, and may be up from 0 up to 1, 2.5 or 5 weight percent, based on the weight of the binder composition or pigment composition.

In one embodiment of the printing paper according to the present invention, when the binder composition comprises a mixture of the at least one water-soluble polymer and the at least one starch, without comprising the at least one protein, it comprises the at least one water-soluble polymer and the at least one starch in a total amount of at least 75 weight percent, or of from 75 to 97.5 weight percent, preferably in an amount of at least 85 weight percent, or of from 85 to 97.5 weight percent, based on the weight of the binder composition. In one embodiment, the binder composition may comprise the at least one water-soluble polymer and the at least one starch in a total amount of at least 97.5 weight percent, more preferably of at least 99 weight percent or 100 weight percent.

In one embodiment of the printing paper according to the present invention, when the binder composition comprises a mixture of the at least one protein, the at least one starch, and the at least one water-soluble polymer, it comprises the mixture of the at least one protein, the at least one starch and the at least one water-soluble polymer in a total amount of at least 75 weight percent, or of from 75 to 97.5 weight percent, preferably in an amount of at least 85 weight percent, or of from 85 to 90 weight percent, based on the weight of the binder composition. Alternatively, or in addition to, the aforementioned embodiment, the binder composition comprises the mixture of the at least one protein and the at least one starch in a total amount of from 75 to 87.5 weight percent, based on the weight of the binder composition. In particular, within said mixtures, the at least one water-soluble polymer is comprised in an amount of from 2.5 to 25 weight percent, preferably in an amount of from 2.5 to 5 weight percent, based on the weight of the binder composition and/or the at least one protein is comprised in an amount of at least 10 weight percent, preferably an amount of from 15 to 75 weight percent, more preferably in an amount of from 10 to 20, weight percent, based on the weight of the binder composition, preferably with the remainder weight percent of the at least 75 weight percent, or the of from 75 to 97.5 weight percent, of the at least 85 weight percent, or the of from 85 to 90 weight percent of the mixture of the at least one protein, the at least one starch and the at least one water-soluble polymer being the at least one starch.

In one embodiment of the printing paper according to the present invention, when the binder composition comprises a mixture of the at least one protein, the at least one starch, and the at least one water-soluble polymer, it comprises the mixture of the at least one protein, the at least one starch and the at least one water-soluble polymer in a total amount of from 85 to 90 weight percent, based on the weight of the binder composition, and comprises the mixture of the at least one protein and the at least one starch in a total amount of from 75 to 87.5 weight percent, based on the weight of the binder composition, where the at least one water-soluble polymer is comprised in an amount of from 2.5 to 5 weight percent, based on the weight of the binder composition, and the at least one protein is comprised in an amount of 10 to 20 weight percent, based on the weight of the binder composition, preferably with the remainder weight percent of the at least 85 to 90 weight percent of the mixture of the at least one protein, the at least one starch and the at least one water-soluble polymer preferably being the at least one starch.

The remainder of the weight percent in the binder composition, after taking into account the amounts of the at least one protein, the at least one starch, and the at least one water-soluble polymer may be made up by a plasticizer and/or other additives. Plasticizers are used to unfold the protein and improve flexibility of the coating in order to improve folding behavior. In lower grammage papers, the use of the plasticizer is not essential although preferred. Besides plasticizers other additives, such as anti foaming agent, thickeners can be added to compositions.

In one embodiment of the printing paper according to the present invention, the at least one starch is preferably non-cationic starch, and more preferably is modified non-cationic starch such as dextrin, anionic starch, hydroxypropylated or oxidized starch. Because the coating is an anionic system, the calcium carbonates will flocculate when cationic starch is added. Therefore, in the case a cationic starch is used, care should be taken to avoid flocculation of negatively charged components in the binder and/or pigment composition, when making the aqueous ink receiving topcoat composition.

In one embodiment of the printing paper according to the present invention, the at least one water-soluble polymer is a water-soluble polyolefin. An example are synthetic polymers or copolymers, and in particular synthetic water-soluble polyolefins, such as polyvinylalcohol or ethylene vinyl alcohol. It is understood that the at least one water-soluble polymer may be a synthetic polymer or copolymer, or a mixture of both. In particular, the at least one water-soluble polymer may be a mixture of polyvinylalcohol and ethylene vinyl alcohol copolymer, preferably in a weight ratio of 4:6 to 6:4.

In general, the ethylene vinyl alcohol copolymers having a viscosity in the range of about 3 to about 10, preferably of about 3 to 5 mPa's when measured at 4% aqueous solution at 20° C. determined by Brookfield synchronized-motor rotary type.

In general, the polyvinylalcohol having a viscosity in the range of about 3 to 10 mPa·s, when measured at 4% aqueous solution at 20° C. determined by Brookfield synchronized-motor rotary type.

In general, the water-soluble polymer polyvinylalcohol having a degree of degree of hydrolysis [mol.-%] of 95 or more, in particular having a degree of hydrolysis [mol.-%] of 98 or more are preferred.

In the case the water-soluble polymer is a polyvinylalcohol, it preferably has a solubility of at least 20% at 20° C. in water, preferably of more than 25% by weight at 20° C. in water.

In one embodiment of the printing paper according to the present invention, the at least one water-soluble polymer is chosen among polysaccharides such as pectins or galactomannans.

In one embodiment of the printing paper according to the present invention, the weight ratio of the binder composition with respect to 100 parts by weight of the pigment composition is between 5 pph and 20 pph (parts per hundred) of pigment composition.

In one embodiment of the printing paper according to the present invention, the pigment composition comprises, or consists of, inorganic pigment particles such as calcium carbonate particles, titanium dioxide particles, clay mineral particles, or mixtures thereof. Calcium carbonate particles may be chosen from particles of ground calcium carbonate (GCC) or precipitated calcium carbonate (PCC). Clay mineral particles may be chosen, for example, from kaolin clay particles or talc. Other inorganic pigment particles may be barium sulfate, calcium sulfate, zinc oxide, silicic acid, silicate, colloidal silica and so on.

It is a second object of the present invention to provide a use of a printing paper according to the above first object in an offset printing process, flexo printing process, gravure printing process or a digital printing process. As discussed above, when used in said printing processes, the paper printing paper according to the first object exhibits good printability, e.g. absence of mottle, when printed in a printing process that includes the use of fountain solutions, and at the same time exhibits good printability when printed in a digital printing press.

It is a third object of the present invention to provide an aqueous ink receiving topcoat composition comprising a pigment composition and a binder composition, wherein the binder composition comprises a mixture of at least one starch, and one or both of at least one protein and at least one water-soluble polymer, characterized in that the binder composition comprises the at least one protein in an amount of at least 5 weight percent, based on the dry weight of the binder composition. The applicants have found that the aqueous ink receiving topcoat composition according to the third object of the present invention has good rheological properties, in particular in that the viscosity does not exceed an upper threshold when the coating machine is run at high speeds at high solids contents, in particular at solids contents above about 60, or between about 60 to about 70 weight percent, based on the weight of the aqueous ink receiving topcoat composition.

In an embodiment of the aqueous ink receiving topcoat composition according to the third object of the present invention, the viscosity of the aqueous ink receiving topcoat composition is of about 700 to 2000 mPas at 100 rpm, when measured on a Brookfield laboratory viscometer, using spindle #3, at 40° C.

In an embodiment of the aqueous ink receiving topcoat composition according to the third object of the present invention, the aqueous ink receiving topcoat composition may further comprise further additives such as plasticizers, defoaming agents, antibacterial agents, antialgal agents, thickening agents, dyes, antifouling agents and others.

Plasticizers useful in plasticizing the starch component of the aqueous ink receiving topcoat composition may be chosen from polyols such as for example ethylene glycol, glycerol or sorbitol. Other plasticizers useful are ethanolamine and similar compounds. The plasticizers may be used alone or as a mixture of two or more different plasticizers.

It is understood, in general, that in the aqueous ink receiving topcoat composition, the components, which are recited in the context of the ink receiving topcoat, are present in the same amounts in the aqueous ink receiving topcoat composition, when expressed in dry weight. Therefore, a repetition of all the embodiments of the ink receiving topcoat that are directly applicable to aqueous ink receiving topcoat composition are omitted for the sake of conciseness.

In an embodiment of the aqueous ink receiving topcoat composition according to the third object of the present invention, the solids content by weight of the ink receiving topcoat composition is of from 60 to about 70 weight percent, based on the weight of the aqueous ink receiving topcoat composition. In a preferred embodiment, the solids content by weight of the ink receiving topcoat composition corresponds to the dry weight of both the pigment composition and the binder composition, or stated alternatively, to the dry weight of the mixture of at least one starch, and one or both of at least one protein and at least one water-soluble polymer, and of the inorganic pigment particles.

It is a fourth object of the present invention to provide a use of an aqueous ink receiving topcoat composition according to the third object of the present invention, for the manufacture of a printing paper having an ink receiving topcoat, preferably a printing paper according to the first object of the present invention.

It is a fifth object of the present invention to provide a process of manufacturing a printing paper having an ink receiving topcoat, preferably a printing paper according to the first object, wherein the process includes the steps of:
a. forming an aqueous ink receiving topcoat composition from a binder composition and a pigment composition, the binder composition comprising a mixture of at least one starch, and one or both of at least one protein and at least one water-soluble polymer, characterized in that the binder composition comprises the at least one protein in an amount of at least 5 weight percent, based on the dry weight of the binder composition, preferably an aqueous ink receiving topcoat composition according to the third object,
b. applying the aqueous ink receiving topcoat composition, preferably in an amount of about 5 to 25 gsm (grams per square meter), more preferably in an amount of 8 to 15 gsm, on a base paper or a pre-coated paper,
c. drying the aqueous ink receiving topcoat composition such as to form a printing paper having an ink receiving topcoat, preferably a printing paper according to the first object.

The aqueous ink receiving topcoat composition may be applied via known coating methods on known coating apparatuses, such as with for example blade coaters, rod coaters, gravure coaters, size-press coaters, preferably on a blade coater.

In an embodiment of the process according to the fifth object of the present invention, during the step of forming an aqueous ink receiving topcoat composition, the at least one protein is provided as a aqueous protein stock of the at least one protein, preferably having a protein dry weight content of about 40 to 50 weight percent. It has been fund that when the at least one protein is provided as a liquid protein stock instead of a powder, the formation of foam in the aqueous ink receiving topcoat composition can be reduced or even avoided.

### EXAMPLES

Three of prepared aqueous ink receiving topcoat compositions according to the present invention are presented below.

First, an aqueous ink receiving topcoat composition comprising starch in combination with whey protein in its binder composition was compared to an ink receiving topcoat composition that comprised only starch and one that comprised only SB (Styrene-Butadiene) latex. Second, three aqueous ink receiving topcoat compositions comprising starch in combination with synthetic water-soluble polymer in its binder composition were compared to ink receiving topcoat compositions that comprised only starch and comprised only SB latex. Thirdly, three aqueous ink receiving topcoat composition comprised starch in combination with both whey protein and synthetic water-soluble polymer in its binder composition were compared to an ink receiving topcoat composition that comprised only starch and one that comprised only SB latex.

Each of said aqueous ink receiving topcoat compositions was compared to an aqueous ink receiving topcoat composition comprising a SB latex-based binder composition, as well as to an aqueous ink receiving topcoat composition comprising only starch in its binder composition, in terms of printability on an offset printer.

In the below tables, the numbers indicate parts are parts by weight. The ranking for printability reflects the quality of the print, where 1 designates “above target”, 2 designates “below target” and 3 designates “very critical”. 1 is the best in terms of printability, 3 the worst.

The print was run an on commercial 4 color offset press (Shiatsu), for about 500 to 1000 A3 sheets. Sheets were printed with standard 4 colors, KCMY=Black, Cyan, Magenta and Yellow.

Aqueous Ink Receiving Topcoat Composition Comprised Starch in Combination with Whey Protein in its Binder Composition

| | Comparative | Comparative | Inventive |
|---|---|---|---|
| | Latex | Starch | Starch/Whey |
| Calcium carbonate | 100 | 100 | 100 |
| Latex | 7.0 (89.7 | | |
| | w/w %) | | |
| Starch (oxidized) | | 8 (88.9 | 4.8 (53.3 |
| | | w/w %) | w/w %) |
| Whey protein | | | 3.2 (35.6 |
| | | | w/w %) |
| PVOH | 0.8 (10.3 | | |
| | w/w %) | | |
| Plasticizer | | 1 (11.1 | 1 (11.1 |
| | | w/w %) | w/w %) |
| Thickener | 0.15 | | 0.2 |
| Printability | 1.75 | 2.75 | 1.50 |

Aqueous Ink Receiving Topcoat Composition Comprised Starch in Combination with Water-Soluble Polymer in its Binder Composition

| | | | | Inventive | Inventive | Inventive |
|---|---|---|---|---|---|---|
| | Comparative | Comparative | Comparative | Starch/ | Starch/ | Starch/ |
| | Latex | Starch 1 | Starch 2 | EVOH | EVOH | EVOH/PVOH |
| Calcium | 100 | 100 | 100 | 100 | 100 | 100 |
| carbonate | | | | | | |
| Latex | 7.0 (89.7 | | | | | |
| | (w/w %) | | | | | |
| Starch | | 8 (100 | | 6.5 (81.3 | | |
| (oxidized) | | w/w %) | | w/w %) | | |
| Starch | | | 8 (100 | | 6.5 (81.3 | 6.5 (86.7 |
| (dextrin) | | | w/w %) | | w/w %) | w/w %) |
| EVOH | | | | 1.5 (18.7 | 1.5 (18.8 | 0.5 (6.7 |
| | | | | w/w %) | w/w %) | w/w %) |
| PVOH | 0.8 (10.3 | | | | | 0.5 (6.7 |
| | w/w %) | | | | | w/w %) |
| Thickener | 0.15 | | | | | |
| Printability | 1.75 | 2.75 | 2.25 | 1.50 | 1.50 | 1.50 |

Aqueous Ink Receiving Topcoat Composition Comprised Starch in Combination with Both Whey Protein and Water-Soluble Polymer in its Binder Composition

| | | | | Inventive | Inventive | Inventive |
|---|---|---|---|---|---|---|
| | Comparative | Comparative | Comparative | Starch/whey/ | Starch/whey | Starch/whey/ |
| | Latex | Starch 1 | Starch 2 | PVOH | PVOH | PVOH |
| Calcium | 100 | 100 | 100 | 100 | 100 | 100 |
| carbonate | | | | | | |
| Latex | 7.0 (89.7 | | | | | |
| | w/w %) | | | | | |
| Starch | | 8 (88.9 | | 4 (47.4 | | |
| (oxidized) | | w/w %) | | w/w %) | | |
| Starch | | | 8 (88.9 | | 4 (47.4 | 4.6 (54.5 |
| (dextrin) | | | w/w %) | | w/w %) | (w/w %) |
| Starch | | | | 1.6 (18.9 | 1.6 (18.9 | 1.6 (18.9 |
| (hydroxypropylated) | | | | w/w %) | w/w %) | w/w %) |
| Whey | | | | 1.6 (18.9 | 1.6 (18.9 | 1.0 (11.8 |
| protein | | | | w/w %) | w/w %) | w/w %) |
| PVOH | 0.8 (10.3 | | | 0.25 (3.0 | 0.25 (3.0 | 0.25 (3.0 |
| | w/w %) | | | w/w %) | w/w %) | w/w %) |
| Plasticizer | | 1 (11.1 | 1 (11.1 | 1 (11.8 | 1 (11.8 | 1 (11.8 |
| | | w/w %) | w/w %) | w/w %) | w/w % | w/w %) |
| Thickener | 0.15 | | | | | |
| Printability | 1.5 | 2.75 | 2.25 | 1.50 | 1.25 | 1.50 |

As can be seen from the above Tables, the comparative starch-only-based ink receiving topcoat composition in general performed poorly in printability (2.25 was the best score, 3 the worst score), because the fountain solution of the offset printing press interacted with the ink receiving topcoat, and leading to a deleterious effect on the print quality.

As can be seen equally from the above, the comparative latex-based ink receiving topcoat composition in general performed well in printability (1.5 was the best score, 1.75 the worst score).

Finally, the inventive ink receiving topcoat compositions yielded in general equally good, and in some cases even better printability (1.25 was the best score, 1.5 the worst score) when compared to the reference ink receiving topcoat composition based on latex. In particular, the ink receiving topcoat compositions including starch and both protein and water-soluble polymer had, on average, a better printability (<1.5) than the reference latex-based ink receiving topcoat compositions (>1.5). The inventive ink receiving topcoat compositions based on starch in combination with either protein (avg=1.5) or water-soluble polymer (avg=1.5) were in general equivalent to the reference latex-based ink receiving topcoat compositions (avg>1.5).

### LIST OF REFERENCE SIGNS

none

1. A printing paper comprising:
at least one ink receiving topcoat, wherein the ink receiving topcoat comprises
a pigment composition, and
a binder composition,
the binder composition comprising a mixture of 60 to 90 weight percent of at least one starch and 2.5 to 25 weight percent of at least one water-soluble polymer that is soluble in water at 20° C. in an amount of more than 10 mg/l, based on the dry weight of the binder composition.

2. The printing paper according to claim 1, wherein the binder composition, or the binder composition and the pigment composition, or the ink receiving topcoat, are free of water-insoluble synthetic polymer.

3. (canceled)

4. (canceled)

5. The printing paper according to the claim 1, wherein the binder composition further comprises at least one protein, and the binder composition comprises
the at least one protein and the at least one starch in a total amount of from 75 to 97.5 weight percent, based on the weight of the binder composition, and
the at least one water-soluble polymer in an amount of from 2.5 to 25 weight percent, based on the weight of the binder composition.

6. The printing paper according to claim 1, wherein the at least one starch is a modified non-cationic starch selected from the group consisting of dextrin, hydroxypropylated starch, and oxidized starch.

7. The printing paper according to claim 1, wherein the at least one water-soluble polymer is a synthetic polymer or copolymer selected from the group consisting of polyvinylalcohol, ethylene vinyl alcohol, and mixtures of polyvinylalcohol and ethylene vinyl alcohol.

8. The printing paper according to claim 1, wherein the weight ratio of the binder composition with respect to 100 parts by weight of the pigment composition is between 5 pph and 20 pph of pigment composition.

9. The printing paper according to claim 1, wherein the at least one water-soluble polymer is a water-soluble polyolefin selected from the group consisting of polyvinylalcohol, ethylene vinyl alcohol, and mixtures of polyvinylalcohol and ethylene vinyl alcohol.

10. A method of printing, the method comprising:
providing a printing paper comprising at least one ink receiving topcoat, wherein the ink receiving topcoat comprises (a) a pigment composition, and (b) a binder composition, the binder composition comprising a mixture of 60 to 90% of at least one starch and 2.5 to 25% of at least one water-soluble polymer that is soluble in water at 20° C. in an amount of more than 10 mg/l, based on the weight of the binder composition
using the printing paper in an offset printing process, flexo printing process, gravure printing process, or digital printing process.

11. An aqueous ink receiving topcoat composition, comprising
a pigment composition
and a binder composition,
wherein the binder composition comprises
a mixture of 60 to 90% of at least one starch,
and 2.5 to 25% of at least one water-soluble polymer that is soluble in water at 20° C. in an amount of more than 10 mg/l, based on the dry weight of the binder composition.

12. The aqueous ink receiving topcoat composition according to claim 11, wherein the solids content by weight of said composition is of from 60 to about 70, based on the total weight of the aqueous ink receiving topcoat composition.

13. (canceled)

14. A process of manufacturing a printing paper having an ink receiving topcoat, wherein the process includes the steps of:
a. forming an aqueous ink receiving topcoat composition from a binder composition and a pigment composition, the binder composition comprising a mixture of
60 to 90 weight percent of at least one starch,
and 2.5 to 25 weight percent of at least one water-soluble polymer that is soluble in water at 20° C. in an amount of more than 10 mg/l,
based on the dry weight of the binder composition,
b. applying the aqueous ink receiving topcoat composition on a base paper or a pre-coated paper,
c. drying the aqueous ink receiving topcoat composition such as to form a printing paper having an ink receiving topcoat.

15. The process of manufacturing a printing paper having an ink receiving topcoat according to claim 14, wherein during the step of forming an aqueous ink receiving topcoat composition, at least one protein is added to the binder composition as an aqueous protein stock.

16. The printing paper of claim 1, wherein the binder composition further comprises at least one protein.

17. The printing paper according to claim 16, wherein the protein is selected from the group consisting of whey protein, casein, soy protein, and wheat protein.

18. The printing paper according to claim 17 wherein the protein is whey protein.

19. The printing paper according to claim 16 wherein the at least one protein is present in an amount of 5 to 25 weight percent.

20. The topcoat composition according to claim 10, wherein the binder composition further comprises at least one protein.

21. The topcoat composition according to claim 20, wherein the protein is whey protein.

22. The process according to claim 14, wherein the binder composition further comprises at least one protein.

23. The printing paper according to claim 9, wherein the polyvinylalcohol has a degree of hydrolysis [mol.-%] of 98 or more and/or has a solubility of at least 20% at 20° C. in water.
